(19) United States
(12) Patent Application Publication
(10) Pub. No.: US 2010/0310404 A1
(43) Pub. Date: Dec. 9, 2010

(54) APPARATAUS AND METHOD FOR PRODUCING A THREE-DIMENSIONAL OBJECT

(76) Inventor: Ulf Ackelid, Goteborg (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/745,081

(22) PCT Filed: Dec. 6, 2007
(86) PCT No.: PCT/SE07/01084

§ 371 Date: May 27, 2010

(51) Int. Cl. B22F 7/02; B28B 1/00; B22F 3/10

(52) U.S. Cl. 419/6; 425/174.4; 264/461; 425/78

(57) ABSTRACT

The invention concerns an apparatus (1) for producing a three-dimensional object (6) layer by layer using a powdery material which can be solidified by irradiating it with an energy beam (4), said apparatus (1) comprising an electron gun (3) for generating said energy beam (4) and a working area (5) onto which the powdery material is distributed and over which the energy beam (4) sweeps during irradiation. The invention is characterized in that the apparatus (1) is provided with a system (12, 14, 16, 18) for feeding controlled amounts of a reactive gas into the apparatus (1) such as to contact the reactive gas with material positioned on the working area (5), said reactive gas being capable of, at least when having been exposed to the energy beam (4), reacting chemically and/or physically with the material positioned on the working area (5). The invention also concerns a method for operating an apparatus of the above type.

### TECHNICAL FIELD

This invention relates to an apparatus and a method for producing a three-dimensional object layer by layer using a powdery material which can be solidified by irradiating it with an energy beam. In particular, the invention relates to an apparatus provided with an electron gun for generating the energy beam.

### BACKGROUND ART

Equipment for producing a three-dimensional object layer by layer using a powdery material which can be solidified by irradiating it with electromagnetic radiation or an electron beam are known from e.g. U.S. Pat. No. 4,863,538, U.S. Pat. No. 5,647,931, SE524467 and WO2004/056511. Such equipment include for instance a supply of powder, means for applying a layer of powder on a working area, and means for directing the beam over the working area. The powder sinters or melts and solidifies as the beam moves or sweeps over the working area.

General desires in this technical field are to increase the production rate and to improve the product quality in terms of increased strength, homogeneity, surface finish etc. Large efforts in this regard has been made in trying to optimize the energy beam irradiation procedure, by varying e.g. beam power, scanning velocity and scanning pattern, and in trying to improve the powder, by varying e.g. the chemical composition and the particle size distribution of the powder. There is still a need for improvements in this regard.

### DISCLOSURE OF INVENTION

The object of this invention is to provide an apparatus of the above discussed type that makes use of an electron gun for generating the energy beam and that exhibits improved capabilities of speeding up the production process and improving the product quality compared to conventional electron beam equipment. This object is achieved by the apparatus and method defined by the technical features contained in independent claims 1 and 7. The dependent claims contain advantageous embodiments, further developments and variants of the invention.

The invention concerns an apparatus for producing a three-dimensional object layer by layer using a powdery material which can be solidified by irradiating it with an energy beam, said apparatus comprising an electron gun for generating said energy beam and a working area onto which the powdery material is distributed and over which the energy beam sweeps during irradiation. The inventive apparatus is characterized in that the apparatus is provided with a system for feeding controlled amounts of a reactive gas into the apparatus such as to contact the reactive gas with material positioned on the working area, said reactive gas being capable of, at least when having been exposed to the energy beam, reacting chemically and/or physically with the material positioned on the working area.

By feeding a reactive gas, such as hydrogen, hydrocarbons and ammonia, to the working area it is possible to generate controlled chemical and/or physical reactions with the powder, the melt or the solidified material that advantageously affect the production process or the product quality. For instance, hydrogen, hydrocarbons and ammonia can be used to improve the conductivity and the sintering of a metal powder as well as to reduce the amounts of oxygen in a solidified metal. Other examples are that hydrocarbons and carbon monoxide can be used to increase the amounts of carbon in a solidified metal.

The invention also makes it possible to build objects with gradients in their chemical composition, preferably by turning the gas flow on and off in a controlled manner. For instance, to harden the surface of a steel component, i.e. a component produced from steel powder, it is possible to feed a reactive gas containing carbon or nitrogen to the working area only when melting and solidifying the periphery parts of each powder layer, which periphery parts will form the surface of the object. When melting the inner parts of the object, the gas flow is preferably turned off such as to retain the toughness of the bulk material.

Conventionally, apparatuses provided with an electron gun work with vacuum, normally below at least 10⁻² mbar, to avoid that the electron beam interacts with atoms or molecules located between the electron gun and the working area. A traditional ambition has been to produce a vacuum inside the apparatus that is as good as reasonably achievable, i.e. the ambition has been to remove as much gas as reasonably possible from the inside of the apparatus. In contrast to this, the present invention comprises means for supplying gas to the inside of the apparatus.

In an advantageous embodiment of the invention the gas feeding system comprises a valve that is arranged to control the amounts of reactive gas fed to the apparatus. Preferably, the gas feeding system further comprises a gas sensor for determining the amounts of reactive gas present in the apparatus. In a preferred variant of the invention, the apparatus comprises a control unit for controlling the valve, wherein the control unit is electronically connected to the gas sensor and the valve for allowing transfer of information from the sensor and for allowing control of the valve.

In an advantageous embodiment of the invention the reactive gas is a gas, or a mixture of gases, selected from the following group: hydrogen, deuterium, hydrocarbons, gaseous organic compounds, ammonia, nitrogen, oxygen, carbon monoxide, carbon dioxide, nitrogen oxides and nitrous oxide.

The invention also concerns a method for operating an apparatus of the abovementioned type.

### BRIEF DESCRIPTION OF DRAWINGS

In the description of the invention given below reference is made to the following FIGURE, in which:

FIG. 1 shows, in a schematic view, a first preferred embodiment of the invention.

### EMBODIMENT(S) OF THE INVENTION

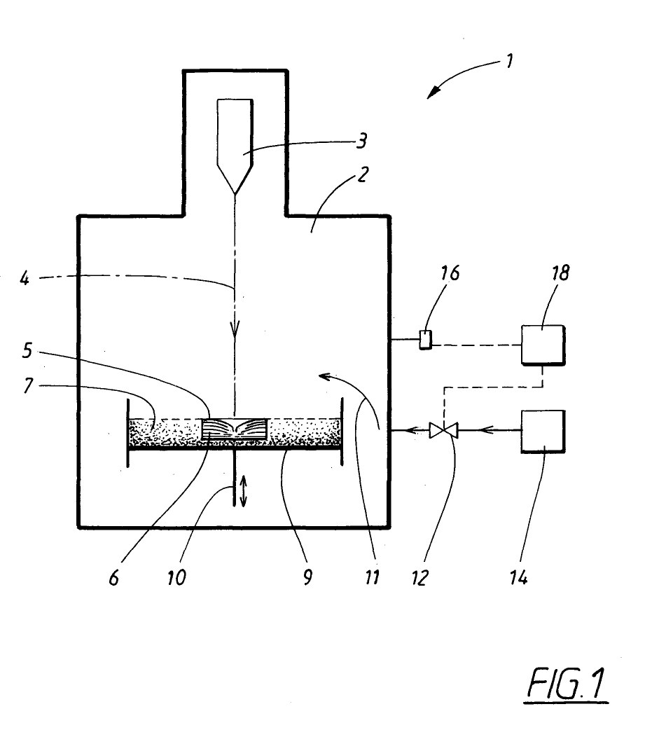

FIG. 1 shows, in a schematic view, a first preferred embodiment of an inventive apparatus 1 for producing a three-dimensional object 6 layer by layer using a powdery material which can be solidified by irradiating it with an energy beam. The apparatus comprises an electron gun 3 generating an electron beam 4 in an evacuated chamber 2. A powder bed 7 is positioned onto a height adjustable working table 9 arranged on a threaded rod 10 for height adjustments. Powder is taken from a powder supply (not shown) and applied layer by layer onto the working table 9. A portion of an upper part of the powder bed 7 forms a working area 5 over which the electron beam 4 sweeps during irradiation. After irradiation of the working area 5, a new layer of powder is distributed on top of the powder bed 7 and thus onto the working area 5. These parts, as well as how to control the electron gun 3, how to establish vacuum in the chamber 2 etc., are well known to the skilled man in the art. Normally, this type of apparatus is operated with a pressure of below 10⁻³ mbar in the chamber 2.

In contrast to a conventional apparatus, the inventive apparatus 1 further comprises a system for feeding a reactive gas into the chamber 2 such that the gas comes in contact with the powdery material positioned on the working area 5. Thus, the gas feeding system is capable of providing an atmosphere of reactive gas above the working area 5. This gas feeding system comprises a gas supply 14, a valve 12 and a gas sensor 16. The sensor 16 and the valve 12 are electronically connected (indicated with dashed lines) to a control unit 18 for transfer of information from the sensor 16 regarding the concentration of gas in the chamber 2 and for allowing control of the valve 12. In this particular example, the control unit 18 also works as a conventional, central control unit for controlling other parts of the apparatus 1, such as the electron gun 3. Gas flowing towards the working area 5 is indicated by an arrow 11.

When so desired, the valve 12 is opened such that the reactive gas can flow from the gas supply 14 into the chamber 2. Gas entering the chamber 2 diffuses rapidly in the embodiment shown here which means that the gas concentration rapidly becomes approximately the same in the whole chamber 2. Thus, the signal received from the sensor 16 approximately corresponds to the concentration of gas more close to the working area 5. Depending on the application, it may be advantageous to feed the gas more directly to the working area 5.

The gas sensor 14 is in this example a conventional pressure sensor. Alternatively, it is possible to use other sensor types, such as gas specific sensors.

Which gas pressure to use depends on the application. To avoid interaction with the electron beam, the gas pressure must be low in comparison with the atmospheric pressure. However, compared to conventional apparatuses, where it normally is aimed at working with a gas pressure that is as low as reasonably achievable, the pressure of the reactive gas can be rather high.

The purpose of feeding the reactive gas to the working area 5 is to generate controlled chemical and/or physical reactions with the powder, the melt or the solidified material that advantageously affect the production process or the product quality. Various gases or gas mixtures can be used to achieve various effects. Further, the reactivity of the gas can be increased when exposed to the electron beam 4. For instance, heavy hydrocarbons CₓH_{y} can be cracked by the electron beam 4 into lighter fragments CHₓ which are more reactive.

The reactive gas can be fed to the chamber 2 in a continuous manner so that the gas concentration above the working area 5 is approximately constant during the production process. Alternatively, the gas can be fed in an intermittent manner in order to affect certain production steps or object parts only.

With regard to chemical effect on metallic powder, a reactive gas can be used to reduce surface oxides and/or to add carbon and/or nitrogen to the powder. This way it is possible to increase the conductivity at the powder surfaces which results in an improved sintering of the powder. An improved sintering means that the sintering process, and thus the production process, is speeded up and that the product becomes more homogeneous and gets more even surfaces. Further, chemical reactions with the powder can also be used to prevent adsorption of residual gas impurities present in the vacuum.

With regard to effect on melted metallic material, a reactive gas can be used to adsorb onto the melt to affect the surface tension and thus the wettability and the melting characteristics; to prevent adsorption of residual gas impurities; and to decrease evaporation of alloying elements (such as aluminium in titanium alloys). By affecting the melting characteristics it is possible to improve the wetting and thereby to decrease the porosity and improve the strength of the product.

With regard to effect on a solidified metallic material, a reactive gas can be used to adjust the content of carbon, nitrogen and oxygen, which in turn has an influence on the tensile properties and/or the hardness of the material. It may be noted that e.g. a change in oxygen content from 0.2% to 0.1% in a titanium alloy have a significant influence on the tensile strength and the elongation of the material.

Hydrogen (H₂), deuterium (D₂) or a mixture thereof (HD) can be used to improve the conductivity and the sintering of the powder and to reduce the content of oxygen in the solidified metal.

Saturated or unsaturated hydrocarbons (CₓH_{y}) can be used to improve the conductivity and the sintering of the powder; to reduce the content of oxygen in the solidified metal; and to increase the content of carbon in the solidified metal. Examples of suitable hydrocarbons for these purposes are methane (CH₄), ethane (C₂H₆), propane (C₃H₈), butane (C₄H₁₀), iso-butane (C₄H₁₀), ethylene (C₂H₄), acetylene (C₂H₂), propene (C₃H₆), buten (C₄H₈), butadien (C₄H₆), cyclo-propane (C₃H₆), cyclo-butane (C₄H₈), propyne (C₃H₄) and liquified petroleum gas (LPG).

Other gaseous organic compounds, such as methyl amine (CH₃NH₂), formaldehyde (CH₂O) and dimethyl ether (CH₃OCH₃), can be used to improve the conductivity and the sintering of the powder as well as to reduce the content of oxygen and increase the content of carbon and/or nitrogen in the solidified metal.

Ammonia (NH₃) can be used to improve the conductivity and the sintering of the powder as well as to reduce the content of oxygen and increase the content of nitrogen in the solidified metal.

Nitrogen (N₂) can be used to improve the conductivity and the sintering of the powder as well as to increase the content of nitrogen in the solidified metal.

Oxygen (O₂) can be used to increase the content of oxygen in the solidified metal.

Carbon monoxide (CO) can be used to improve the conductivity and the sintering of the powder as well as to increase the content of carbon and to change the content of oxygen in the solidified metal.

Carbon dioxide (CO₂) can be used to improve the conductivity and the sintering of the powder as well as to change the content of carbon and/or oxygen in the solidified metal.

Nitrogen oxides (NOₓ), such as nitrogen oxide (NO) and nitrogen dioxide (NO₂), can be used to improve the conductivity and the sintering of the powder as well as to increase the content of nitrogen and to change the content of oxygen in the solidified metal.

Nitrous oxide (N₂O) can be used to improve the conductivity and the sintering of the powder as well as to increase the content of nitrogen and to change the content of oxygen in the solidified metal.

By contacting the working area 5 with the reactive gas only when certain parts of the object 6 are solidified/produced, i.e. only when certain powder layers or certain parts of the powder layers are solidified, it is possible to produce components having a geometrically varying chemical composition. For instance, the gas flow can be turned on or off only when the outer parts of each powder layer is solidified such as to make a component that has another chemical composition at its surfaces compared to its interior parts.

With the expression reactive gas it is meant that the gas, at least after having been exposed to the electron beam 4, is capable of reacting chemically and/or physically with the material in the working area in such a way that it influences the production process and/or the product quality. Whether a certain gas can be regarded as reactive or not depends primarily on the material (metal) it is intended to react with and the temperature. Inert gases, such as argon, can normally not be regarded as reactive. Which gas or gas mixture to use depends on the powder used, the temperature and which reaction(s) that is/are desired.

As an example, hydrogen is suitable for removing oxygen from steel. Thus, hydrogen can be used to solve the specific problem of too high oxygen content in steel powder that is recycled in the process, i.e. metallic particles that have been positioned onto the working area but have avoided being solidified, and that then have been brought back to the powder supply. The oxygen content in the steel increases during recycling. Feeding hydrogen to the working area 5 increases the lifetime of recycled steel powder.

The invention is not limited by the embodiments described above but can be modified in various ways within the scope of the claims.

1-10. (canceled)

11. An apparatus for producing a three-dimensional object layer by layer using a powdery material which can be solidified by irradiating it with an energy beam, said apparatus comprising:
an electron gun for generating said energy beam in the form of an electron beam; and
a working area onto which the powdery material is distributed and over which the electron beam sweeps during irradiation, wherein:
the working area is arranged in an evacuated chamber; and
the apparatus is provided with a system for feeding controlled amounts of a reactive gas into the evacuated chamber such as to contact the reactive gas with material positioned on the working area, said reactive gas being capable of, at least when having been exposed to the electron beam, reacting at least one of chemically or physically with the material positioned on the working area.

12. The apparatus according to claim 11, wherein the gas feeding system comprises a valve that is arranged to control the amounts of reactive gas fed to the apparatus.

13. The apparatus according to claim 12, wherein the gas feeding system comprises a gas sensor for determining the amounts of reactive gas present in the apparatus.

14. The apparatus according to claim 13, wherein the apparatus comprises a control unit for controlling the valve, said control unit being electronically connected to the gas sensor and the valve for allowing transfer of information from the sensor and for allowing control of the valve.

15. The apparatus according to claim 11, wherein the reactive gas comprises at least one gas, or a mixture of gases, selected from a group consisting of: hydrogen, deuterium, hydrocarbons, gaseous organic compounds, ammonia, nitrogen, oxygen, carbon monoxide, carbon dioxide, nitrogen oxides, and nitrous oxide.

16. The apparatus according to claim 11, wherein the material positioned on the working area is made of metal.

17. A method for producing a three-dimensional object layer by layer using a powdery material which can be solidified by irradiating it with an energy beam, using an apparatus comprising an electron gun for generating said energy beam in the form of an electron beam and a working area onto which the powdery material is distributed and over which the electron beam sweeps during irradiation, wherein the working area is arranged in an evacuated chamber and the method comprises the following step:
feeding controlled amounts of a reactive gas into the evacuated chamber such as to contact the reactive gas with material positioned on the working area, said reactive gas being capable of, at least when having been exposed to the electron beam, reacting at least one of chemically or physically with the material positioned on the working area.

18. The method of claim 17, further comprising the step of opening a valve that is arranged to control the amounts of reactive gas fed to the apparatus.

19. The method of claim 17, further comprising the step of reading a signal from a gas sensor arranged to determine the amounts of reactive gas present in the apparatus.

20. The method of claim 17, wherein the reactive gas comprises at least one gas, or a mixture of gases, selected from a group consisting of: hydrogen, deuterium, hydrocarbons, gaseous organic compounds, ammonia, nitrogen, oxygen, carbon monoxide, carbon dioxide, nitrogen oxides, and nitrous oxide.
